(19) United States
(12) Patent Application Publication
(10) Pub. No.: US 2014/0152764 A1
(43) Pub. Date: Jun. 5, 2014

(54) INFORMATION PROCESSING SYSTEM, INFORMATION PROCESSING APPARATUS, STORAGE MEDIUM HAVING STORED THEREIN INFORMATION PROCESSING PROGRAM, AND INFORMATION TRANSMISSION/RECEPTION METHOD

(71) Applicant: NINTENDO CO., LTD., Kyoto (JP)

(72) Inventors: Satoshi KIRA, Kyoto (JP); Akihiro Umehara, Kyoto (JP); Toshiaki Suzuki, Kyoto (JP)

(73) Assignee: NINTENDO CO., LTD., Kyoto (JP)

(21) Appl. No.: 14/078,855

(22) Filed: Nov. 13, 2013

(30) Foreign Application Priority Data
Dec. 4, 2012 (JP) 2012-265766
Jun. 24, 2013 (JP) 2013-131859

(51) Int. Cl. H04N 5/232

(52) U.S. Cl. CPC H04N 5/23238
USPC 348/36

(57) ABSTRACT

An example of an information processing system includes a plurality of information processing apparatuses each capable of displaying, on a display device, a plurality of panoramic images associated with points on a map. A transmission-side apparatus determines a target point on the basis of an operation of a user, and displays, on a first display device, an image of a partial area, corresponding to a line-of-sight direction determined in accordance with an operation of the user, of a panoramic image associated with the target point. The transmission-side apparatus stores path information regarding a path along which the target point is moved during a predetermined period. A reception-side apparatus acquires the two or more panoramic images identified by the path information stored in the transmission-side apparatus, and displays, on a second display device, the acquired two or more panoramic images in an order identified by the path information.

### CROSS REFERENCE TO RELATED APPLICATION

The disclosure of Japanese Patent Application Nos. 2012-265766, filed on Dec. 4, 2012, and 2013-131859, filed on Jun. 24, 2013, are incorporated herein by reference.

### FIELD

The technology herein relates to an information processing system, an information processing apparatus, a storage medium having stored therein an information processing program, and an information transmission/reception method in the information processing system, which allow a panoramic image to be displayed on a display device.

### BACKGROUND AND SUMMARY

Hitherto, there is a technology in which using a panoramic image representing the real world, a line-of-sight direction is changed in accordance with an operation of a user and an image of the real space is displayed. In addition, in this technology, panoramic images are associated with a plurality of points on a map, a panoramic image at a current point is displayed, and it is possible to change the displayed panoramic image by moving the current point.

In the above technology, it is possible to merely view a panoramic image while moving a point, and there is room for improvement in presenting the content of a panoramic image having further enhanced interest.

Therefore, the present application discloses an information processing system, an information processing apparatus, a storage medium having stored therein an information processing program, and an information transmission/reception method, which allow a panoramic image having enhanced interest to be presented.

(1) An example of an information processing system described in the present specification includes a plurality of information processing apparatuses each capable of displaying, on a display device, a plurality of panoramic images associated with points on a map.

A transmission-side apparatus of the plurality of information processing apparatuses includes a point determination unit, a first image display unit, and a path information storage unit. The point determination unit is configured to determine one of points on the map as a target point on the basis of an operation of a user. The first image display unit is configured to display, on a first display device, an image of a partial area, corresponding to a line-of-sight direction determined in accordance with an operation of the user, of a panoramic image associated with the target point. The path information storage unit is configured to store path information which allows for identification of two or more panoramic images of panoramic images associated with points on a path along which the target point is moved during a predetermined period, and identification of an order of the two or more panoramic images.

A reception-side apparatus of the plurality of information processing apparatuses includes a panoramic image acquisition unit and a second image display unit. The panoramic image acquisition unit is configured to acquire the two or more panoramic images identified by the path information stored in the transmission-side apparatus. The second image display unit is configured to display, on a second display device, the acquired two or more panoramic images in the order identified by the path information.

The “first display device” may be separate from the transmission-side apparatus or may be integrated with the transmission-side apparatus. In addition, the “second display device” may be separate from the reception-side apparatus or may be integrated with the reception-side apparatus.

The “path information” is any information which allows for identification of a panoramic image. For example, in addition to panoramic image information in the embodiment described later, information which allows for identification of a point associated with a panoramic image (position information in an embodiment described later) corresponds to the “path information”.

Each panoramic image acquired by the “panoramic image acquisition unit” is not limited to an entire panoramic image, and may be an image of a partial area of a panoramic image. For example, when an image of a partial range of a panoramic image is displayed on the reception-side apparatus, only a partial image within a display range may be acquired.

According to the configuration of the above (1), a path along each point at which a panoramic image is reproduced at the transmission side is transmitted to the reception side. Thus, at the reception side, it is possible to view the panoramic images along the path along which the user of another apparatus (the transmission-side apparatus) views the panoramic images. According to the configuration of the above (1), it is possible to view a panoramic image in an unconventional way of enjoyment, and it is possible to present a panoramic image having enhanced interest.

(2) The information processing system may further include a server capable of communicating with each information processing apparatus. In this case, the transmission-side apparatus may further include a transmission unit configured to transmit the stored path information to the server. The server may store the path information transmitted from the transmission-side apparatus. The panoramic image acquisition unit may acquire the panoramic images identified by the path information stored in the server.

According to the configuration of the above (2), since the path information is stored in the server, it is possible to easily share the path information by a large number of information processing apparatuses.

(3) The transmission unit may transmit, to the server, the path information with a message inputted by the user. In this case, the server may store the message and first presentation information representing the path information, in a state where the message and the first presentation information are viewable by each information processing apparatus.

According to the configuration of the above (3), in the reception-side apparatus, it is possible to view a message and presentation information as information regarding path information posted to the server. Thus, it is possible to present the posted path information in an easy-to-understand manner for the reception-side user.

(4) The first presentation information may be image information obtained from the panoramic image identified by the path information represented by the first presentation information.

According to the configuration of the above (4), the image information obtained from the panoramic image identified by the path information is displayed as presentation information on the reception-side apparatus. According to this, it is possible to present posted path information in an easy-to-understand manner for the reception-side user.

(5) The transmission-side information processing apparatus may further include an individual information storage unit configured to store individual point information which allows for identification of a panoramic image associated with one point designated by the user. In this case, the server may generate first presentation information representing path information transmitted from one or more transmission-side apparatuses, for each path information, and may generate second presentation information representing individual point information transmitted from one or more transmission-side apparatuses, for each individual point information. The reception-side apparatus may further include a list display section configured to: acquire the first presentation information from the server and display the first presentation information in a list on the second display device in accordance with a first instruction of a user; and acquire the second presentation information from the server and display the second presentation information in a list on the second display device in accordance with a second instruction of the user.

According to the configuration of the above (5), in the reception-side apparatus, a list of posted path information and a list of posted individual point information are separately displayed, and the reception-side user is allowed to separately view these lists. According to this, it is possible to distinguishably present the posted path information and the posted individual point information in an easy-to-understand manner for the user.

(6) For each panoramic image identified by the path information, the path information storage unit may store path information including line-of-sight direction information indicating a line-of-sight direction determined on the basis of a line-of-sight direction when the panoramic image is displayed on the first display device.

According to the configuration of the above (6), the transmission-side apparatus is able to store the line-of-sight direction at the point associated with the panoramic image identified by the path information.

(7) The second image display unit may display, on the second display device, an image of a partial area, determined on the basis of the line-of-sight direction information included in the path information, of the acquired panoramic image.

According to the configuration of the above (7), it is possible to determine a line-of-sight direction for the panoramic image displayed at the reception side, by reflecting the line-of-sight direction for the panoramic image displayed at the transmission side, and it is possible to present a panoramic image having enhanced interest.

(8) The path information storage unit may store path information which allows for identification of panoramic images associated with some points that meet a predetermined condition, among points that become target points during the predetermined period.

According to the configuration of the above (8), it is possible to reduce a data amount of the path information as compared to the case where the path information includes panoramic images associated with all the points on the path.

(9) The path information storage unit may select the some points on the basis of a characteristic, on the map, which is calculated from map data representing the map, and may store path information which allows for identification of panoramic images associated with the selected points.

According to the configuration of the above (9), the transmission-side apparatus is able to select a point in consideration of the characteristic on the map, and thus is able to appropriately perform a process of selecting a point.

It is noted that the present specification discloses an example of an information processing apparatus including the same means as those of the transmission-side apparatus or the reception-side apparatus in the information processing system in the above (1) to (9). In addition, the present specification discloses an example of a storage medium having stored therein an information processing program that causes a computer of an information processing apparatus to operate as the same means as those of the transmission-side apparatus or the reception-side apparatus in the information processing system in the above (1) to (9). Moreover, the present specification discloses an information transmission/reception method executed in the information processing system in the above (1) to (9).

According to the above information processing system, the above information processing apparatus, the above storage medium having stored therein the information processing program, and the above information transmission/reception method, since the path information stored at the transmission side is transmitted to the reception side, it is possible to present a panoramic image in an unconventional way of enjoyment at the reception side, and it is possible to present a panoramic image having enhanced interest.

These and other objects, features, aspects and advantages will become more apparent from the following detailed description when taken in conjunction with the accompanying drawings.

### BRIEF DESCRIPTION OF THE DRAWINGS

FIG. 1 is a block diagram showing an example of a non-limiting information processing system according to an embodiment;

FIG. 2 is a diagram showing an example of a transmission-side apparatus and an example of an image displayed thereon;

FIG. 3 is a diagram showing an example of a three-dimensional model arranged in a three-dimensional space;

FIG. 4 is a diagram showing an example of a three-dimensional space set for displaying a panoramic image;

FIG. 5 is a diagram schematically showing an example of the configuration of map data;

FIG. 6 is a diagram showing an example of a map on which a path is stored;

FIG. 7 is a diagram showing an example of the data structure of path information;

FIG. 8 is a diagram showing an example of data stored in a server;

FIG. 9 is a timing chart showing an example of flow of a process in the information processing system;

FIG. 10 is a diagram showing an example of a view image regarding path information;

FIG. 11 is a flowchart showing an example of flow of a path storage process performed by the transmission-side apparatus in the embodiment; and

FIG. 12 is a flowchart showing an example of flow of an image reproduction process performed by a reception-side apparatus in the embodiment.

### DETAILED DESCRIPTION OF NON-LIMITING EXAMPLE EMBODIMENTS

[1. Configuration of Information Processing System]

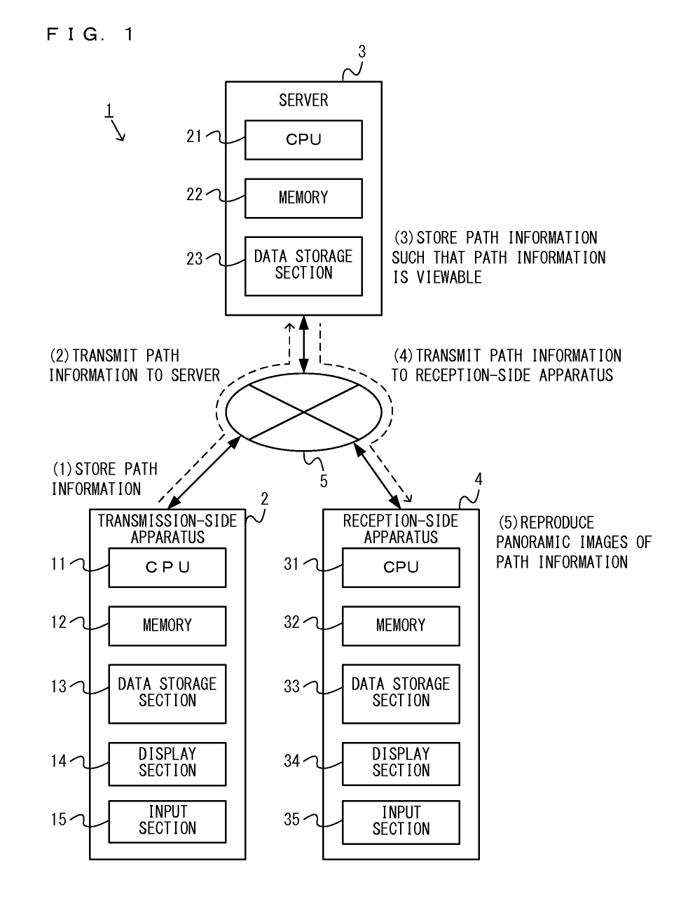

Hereinafter, an information processing system, an information processing apparatus, an information processing program, and an information transmission/reception method according to an example of an embodiment will be described. FIG. 1 is a block diagram showing an example of the information processing system according to the present embodiment. In FIG. 1, an information processing system 1 includes a transmission-side apparatus 2, a server 3, and a reception-side apparatus 4. The respective apparatuses 2 to 4 are capable of communicating with each other via a network 5.

In the present embodiment, the transmission-side apparatus 2 performs a path storage process of displaying panoramic images and storing path information (its details will be described later), and the like ((1) shown in FIG. 1). The path information is transmitted to the server 3 ((2) shown in FIG. 1), and the server 3 stores therein the path information such that the path information is viewable from another information processing apparatus ((3) shown in FIG. 1). The reception-side apparatus 4 receives the path information from the server 3 ((4) shown in FIG. 1) and performs a panoramic image reproduction process of displaying (reproducing) the panoramic images, and the like on the basis of the path information ((5) shown in FIG. 1). In this manner, in the information processing system 1, it is possible to share the path information between information processing apparatuses (the transmission-side apparatus 2 and the reception-side apparatus 4) which display panoramic images at a plurality of points on a map. Hereinafter, the configurations of the respective apparatuses 2 to 4 in the information processing system 1 will be described.

As shown in FIG. 1, the transmission-side apparatus 2 includes a CPU 11, a memory 12, a data storage section 13, a display section 14, and an input section 15. In addition, the reception-side apparatus 4 is an information processing apparatus of the same type as the transmission-side apparatus 2, and has the same configuration as that of the transmission-side apparatus 2. Specifically, the reception-side apparatus 4 includes a CPU 31, a memory 32, a data storage section 33, a display section 34, and an input section 35. It is noted that the transmission-side apparatus 2 and the reception-side apparatus 4 may be information processing apparatuses of different types (having different configurations). In addition, each of the information processing apparatuses 2 and 4 may be an information processing apparatus in any form such as a personal computer, a game apparatus, a handheld terminal, or a smart phone. Hereinafter, the configuration of the transmission-side apparatus 2 will be described, and the description in (Configuration of transmission-side apparatus) described below is the same for the configuration of the reception-side apparatus 4.

(Configuration of Transmission-Side Apparatus)

The CPU 11 performs information processing (the above path storage process in the CPU 11 of the transmission-side apparatus 2, and the above image reproduction process in the CPU 31 of the reception-side apparatus 4) by executing a predetermined information processing program using the memory 12. It is noted that the transmission-side apparatus 2 may have any configuration as long as the information processing apparatus 2 is able to perform the information processing, and, for example, a part or the entirety of the information processing may be performed by a dedicated circuit. The data storage section 13 stores the above path information and the like therein.

The transmission-side apparatus 2 includes the display section 14 composed of, for example, an LCD (liquid crystal display). In addition, the transmission-side apparatus 2 includes the input section 15. The input section 15 is any device that receives an operation of the user and generates operation data representing the operation of the user. In the present embodiment, the transmission-side apparatus 2 includes, as the input section 15, an operation section, a touch panel, and a gyro-sensor. In the present embodiment, the operation section includes buttons and sticks. The touch panel is provided on the screen of the display section (LCD) 14. The gyro-sensor is an example of an attitude sensor for calculating the attitude of the transmission-side apparatus 2 (or the input section 15). In another embodiment, the transmission-side apparatus 2 may calculate the attitude of the transmission-side apparatus 2 (or the input section 15) by any method, and may not have a function to calculate the attitude.

It is noted that in another embodiment, the function of the transmission-side apparatus 2 may be realized by a plurality of apparatuses. For example, a terminal system that includes a main information processing apparatus which performs main information processing and a terminal apparatus which includes a display section 14 and an input section 15 may be used instead of the transmission-side apparatus 2. In addition, in another embodiment, at least a part of the information processing performed by the transmission-side apparatus 2 may be distributed to and performed by a plurality of apparatuses that are able to perform communication via a network (a wide-area network and/or a local network).

In addition, in the present embodiment, a description will be given on the assumption that for the purpose of describing an operation in the information processing system 1 in an easy-to-understand manner, the transmission-side apparatus 2 has a transmission-side function (a function to perform the above path storage process) and the reception-side apparatus 4 has a reception-side function (a function to perform the above image reproduction process). It is noted that a single information processing apparatus may have both the transmission-side function and the reception-side function. In other words, there may be no difference in function between the transmission-side apparatus 2 and the reception-side apparatus 4, and each of the apparatuses 2 and 4 may have both the transmission-side function and the reception-side function.

(Configuration of Server)

The server 3 is an information processing apparatus in any form and includes a CPU 21, a memory 22, and a data storage section 23. The CPU 21 performs information processing performed at the server side (a server-side process), by executing a predetermined information processing program using the memory 22. It is noted that the server 3 may have any configuration as long as the server 3 is able to perform the information processing, and, for example, a part or the entirety of the information processing may be performed by a dedicated circuit. The server 3 may be a server apparatus composed of a single information processing apparatus, or may be a server apparatus group composed of a plurality of information processing apparatuses. In addition, the data storage section 23 stores therein data (path information and the like) transmitted from the transmission-side apparatus 2. It is noted that data stored in the data storage section 23 will be described later.

[2. Display of Panoramic Image]

Next, the outline of a process of displaying an image in the present embodiment will be described. In the present embodiment, each of the information processing apparatuses 2 and 4 displays an image of a partial area of a panoramic image (an area within a field-of-view range corresponding to a line-of-sight direction operated by the user).

(Panoramic Image)

In the present embodiment, a panoramic image is an image whose range is wider than a range displayed on the display device. In other words, with regard to the panoramic image, an image in a part of the area of the panoramic image is basically displayed on the display device. In the present embodiment, of the panoramic image, an area included in a field-of-view range determined in accordance with the above line-of-sight direction is a range displayed on the display device (a display range). It can also be said that the panoramic image is an image on which a process of determining a display range in accordance with a line-of-sight direction in a three-dimensional space is performed (when the panoramic image is displayed on the display device). The display range may be changed (moved), for example, in accordance with an operation of the user. In the case where the display range is moved, it can also be said that the panoramic image is an image for which a line-of-sight direction is changed by change of the display range. As described above, an image of a partial area (a partial image) of the panoramic image is normally displayed, but the information processing system 1 may have a function to display the entirety of the panoramic image on the display device. For example, in the case where a plurality of display devices are used in the information processing system 1, the entirety of the panoramic image may be displayed on some of the display devices.

It is noted that in the present embodiment, a panoramic image having a viewing angle in all directions (360°) with regard to the up-down direction (pitch direction) and the left-right direction (yaw direction) is used. However, the panoramic image may include a dead angle, and, for example, its viewing angle may be about 180°. An image whose range is wider than a range displayed on the display device (a field-of-view range) is a panoramic image.

(Operation of Line-of-Sight Direction)

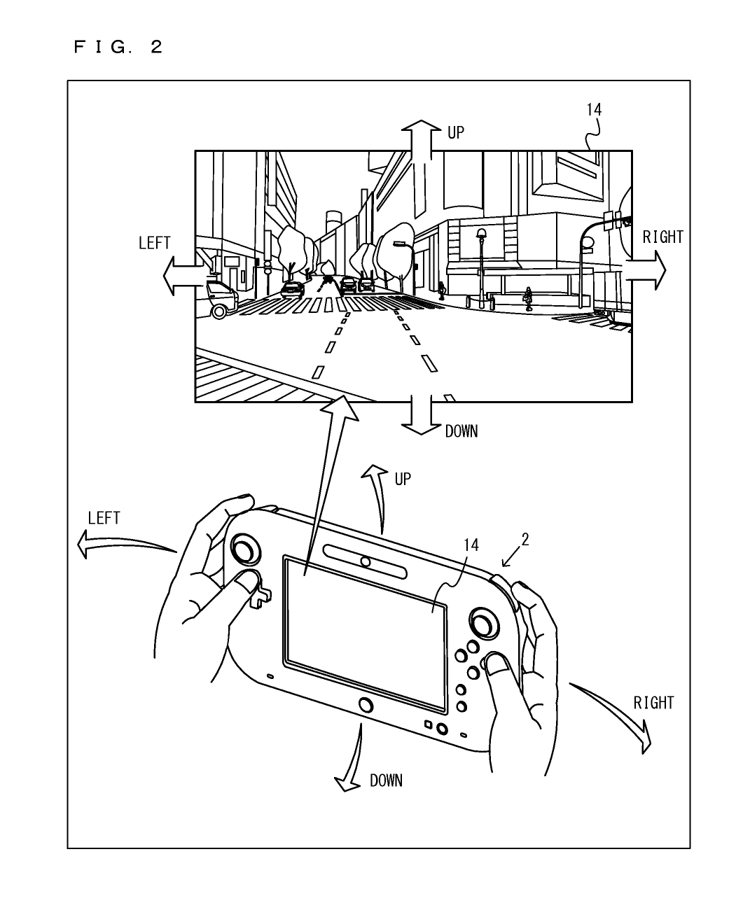

FIG. 2 is a diagram showing an example of the transmission-side apparatus 2 and an example of an image displayed thereon. As shown in FIG. 2, in the present embodiment, (a part of the range of) a panoramic image representing the real world is displayed on the display section 14 of the transmission-side apparatus 2. It is noted that a description will be given with the transmission-side apparatus 2 as an example below, but regarding a process of displaying an image in a line-of-sight direction (a part of a panoramic image) in accordance with an operation of the user, the same applies to the reception-side apparatus 4.

In the present embodiment, the line-of-sight direction is controlled by an operation of the user changing the attitude of the transmission-side apparatus 2. For example, as shown in FIG. 2, when the transmission-side apparatus 2 is rotated in the up-down direction (pitch direction) or the left-right direction (yaw direction), the line-of-sight direction for the image displayed on the display section 14 (a line-of-sight direction of a virtual camera described later) is changed in the up-down direction or the left-right direction. Specifically, the transmission-side apparatus 2 calculates the attitude of the transmission-side apparatus 2 on the basis of an angular velocity detected by the gyro-sensor and calculates the line-of-sight direction on the basis of the calculated attitude. By controlling the line-of-sight direction in accordance with the attitude of the transmission-side apparatus 2 as described above, the user is allowed to change a display range of the panoramic image by an operation of changing the attitude of the transmission-side apparatus 2 so as to look over the surrounding. According to this, the user is allowed to look over the real space represented by the panoramic image, and thus is allowed to have an experience as if being actually at a location of the viewpoint for the panoramic image. It is noted that in another embodiment, the control of the line-of-sight direction may be performed in any manner.

(Method for Displaying Panoramic Image)

In the present embodiment, the information processing system 1 sets a virtual three-dimensional space for displaying a panoramic image, and arranges a three-dimensional model in the three-dimensional space. Then, the information processing system 1 displays a panoramic image by a method in which a panoramic moving image is rendered as a texture on the three-dimensional model. A detailed description will be given below.

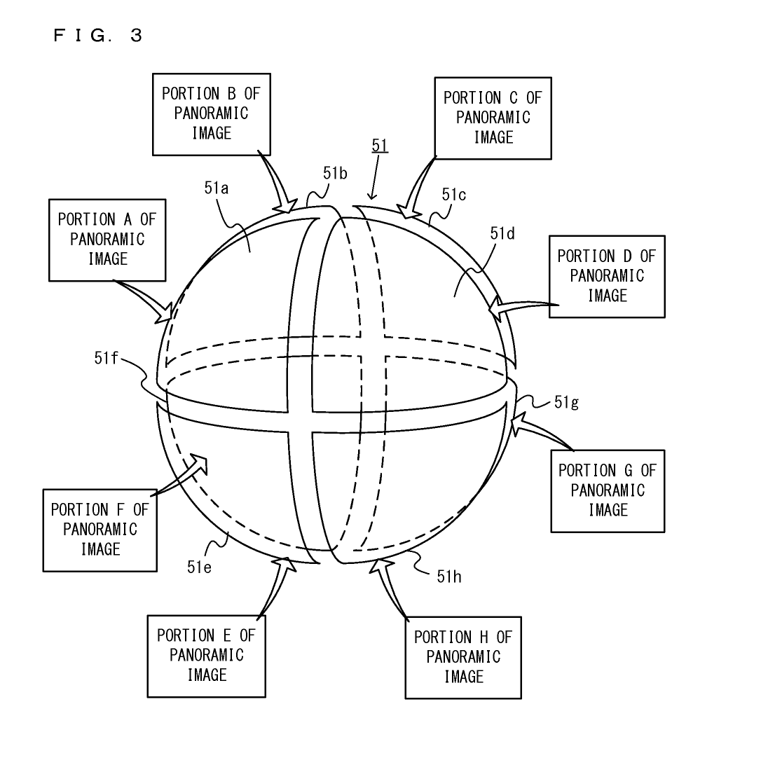

FIG. 3 is a diagram showing an example of the three-dimensional model arranged in the three-dimensional space. As shown in FIG. 3, in the present embodiment, eight partial models 51a to 51h are arranged in the three-dimensional space, as three-dimensional models for rendering a panoramic image. Each of the partial models 51a to 51h has a curved surface shape that is a part of a spherical surface, and the partial models 51a to 51h form a sphere when being combined with each other. As shown in FIG. 3, the eight partial models 51a to 51h are spherically arranged.

On each of the partial models 51a to 51h, a part of the panoramic image is rendered. Here, the panoramic image is divided in accordance with the number (eight here) of the partial models 51a to 51h. In the present embodiment, as shown in FIG. 3, each of the portions A to H of the divided panoramic image is rendered on an inner surface of the corresponding partial model (any of the partial models 51a to 51h).

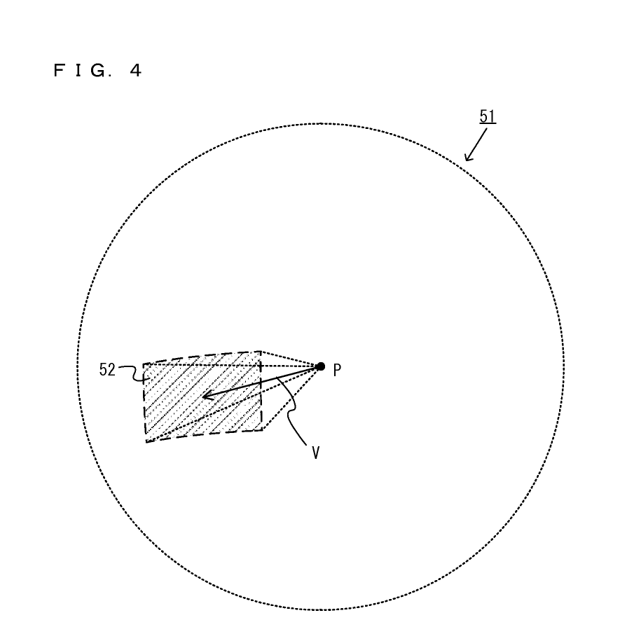

FIG. 4 is a diagram showing an example of the three-dimensional space set for displaying a panoramic image. It is noted that in the following, a model formed by the eight partial models 51a to 51h being spherically arranged is referred to as a “three-dimensional model 51”. In addition, in FIG. 4, for the purpose of clarity of the drawings, the shape of each of the actually arranged partial models 51a to 51h is not shown, and the external shape of the three-dimensional model 51 formed by the partial models 51a to 51h is shown by a dotted line.

The information processing system 1 arranges a virtual camera inside the three-dimensional model 51, for example, at the center P of the three-dimensional model 51. Then, the information processing system 1 generates an image of the three-dimensional model 51 (the inner surface of the three-dimensional model 51) which is seen in the line-of-sight direction V from the position P of the virtual camera (viewpoint). In other words, the information processing system 1 generates an image in a field-of-view range, determined on the basis of the line-of-sight direction V (a shaded area 52 shown in FIG. 4), of the three-dimensional space (three-dimensional model 51), and displays the image on the display device. Here, in generating an image, the information processing system 1 renders a panoramic image as a texture on the inner surface of the three-dimensional model 51. In other words, a part of a panoramic moving image is rendered on the inner surface of the three-dimensional model 51 (some of the partial models 51a to 51h) included in the field-of-view range, and the image in the field-of-view range is displayed. By so doing, of the panoramic image, an image in a range corresponding to the field-of-view range of the virtual camera is generated and displayed.

As described above, in the present embodiment, the line-of-sight direction V of the virtual camera is changed in accordance with an operation of the user. Accordingly, the line-of-sight direction of the virtual camera is changed in accordance with the operation of the user, and thus the display range of the panoramic image is changed (see FIG. 2). It is noted that the field-of-view range of the virtual camera is determined by any method based on the line-of-sight direction V. For example, the field-of-view range is determined so as to be a predetermined range having a center in the line-of-sight direction V. The information processing system 1 may change the size of the field-of-view range, for example, in accordance with an operation of the user.

[3. Map Data Associated with Panoramic Image]

Next, map data used in the present embodiment will be described. In the present embodiment, the map data is prepared, and a panoramic image is prepared for each of a plurality of points on a map represented by the map data. Although a detailed description will be given later, the user is allowed to display a plurality of panoramic images for which the positions of viewpoints are different from each other, by moving a point on the map.

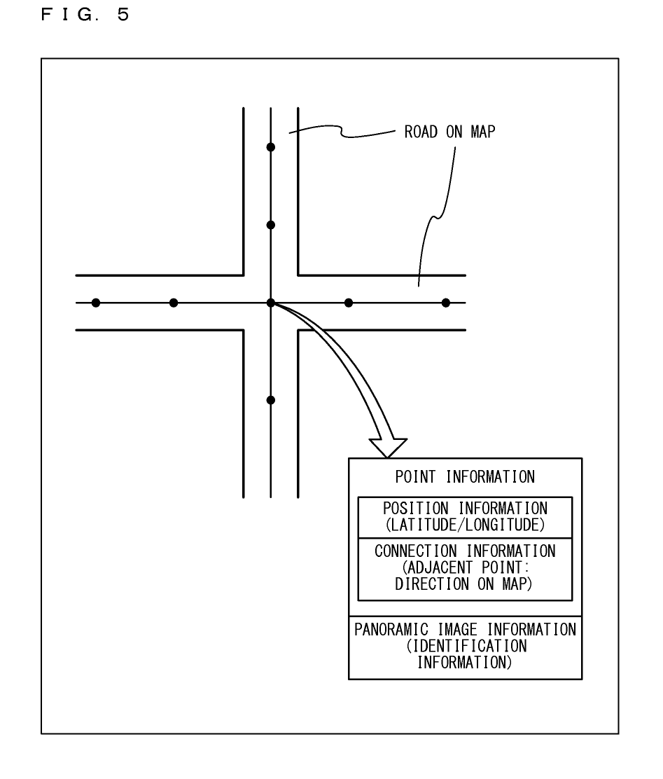

FIG. 5 is a diagram schematically showing an example of the configuration of the map data. Each point shown in FIG. 5 represents a point, on the map, with which a panoramic image is associated. The points are arranged, for example, along a road on the map. In addition, a line segment connecting points to each other represents that the points are connected to each other. In this manner, the map data indicates a plurality of points on the map and connection relationships between the points. The points and the connection relationships therebetween in the map data may be represented, for example, by nodes representing points, and links connecting the nodes to each other.

As shown in FIG. 5, the map data stores point information representing a point that is set on the map, for each point. In the present embodiment, the point information includes position information and connection information. The position information is information indicating the position of the point on the map. For example, the position information indicates a latitude and a longitude on the map. The connection information includes adjacency information indicating another point adjacent to the point (an adjacent point). The adjacency information may be information on a node representing the adjacent point, or information on a link representing connection between the point and the adjacent point. In addition, in the present embodiment, the connection information includes direction information indicating a direction to the adjacent point on the map as seen from the point.

In the present embodiment, a panoramic image is associated with each point. Specifically, in the map data, panoramic image information is stored so as to be associated with point information (see FIG. 5). The panoramic image information is, for example, identification information (ID) with which each panoramic image is identifiable. As described above, in the present embodiment, a plurality of panoramic images are prepared, and each panoramic image is associated with a point on the map. It is noted that a panoramic image associated with a certain point is a panoramic image obtained by photographing the surrounding of a viewpoint that is the certain point.

It is noted that the configuration of the map data is not limited to the above and may be any configuration in which a panoramic image is associated with a point. For example, in another embodiment, the map data may not include the direction information. In addition, the map data may further include information other than the above information. For example, the map data may further include information on the altitude of a point. The information on the altitude is, for example, information indicating which floor of a building a point is located on, in the case where the point is set within the building on the map. As described above, a point in the map data is not limited to a point on a road, and may be a point within a building.

[4. Operation in Information Processing System]

Next, an operation in the information processing system 1 will be described. In the present embodiment, first, when a panoramic image is displayed on the transmission-side apparatus 2 while a point is moved by an operation of the user, a path along which the point is moved is stored, and path information thereof is transmitted to the server 3. Then, in the reception-side apparatus 4, the path information is acquired from the server 3 by an operation of the user, and a panoramic image at a point on the path is reproduced (displayed). In this manner, in the present embodiment, it is possible to share a path regarding a panoramic image by the reception side and the transmission side.

(4-1: Operation in Transmission-Side Apparatus)

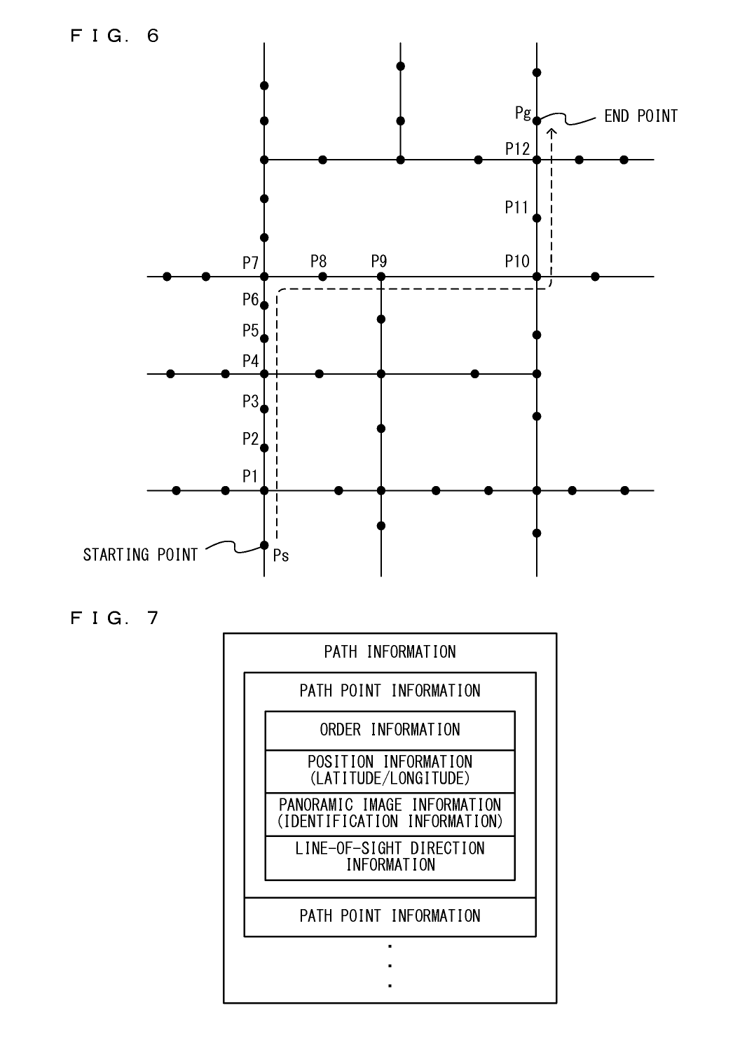

Hereinafter, an operation performed when path information is stored in the transmission-side apparatus 2 and transmitted to the server 3 will be described. FIG. 6 is a diagram showing an example of a map on which a path is stored. Hereinafter, a description will be given with, as an example, a case where a path which goes from a starting point Ps to points P1 to P12 in order and finally to an end point Pg is stored on the map shown in FIG. 6.

In storing a path, the transmission-side apparatus 2 starts the storing in accordance with a predetermined storage start instruction being performed from the user. Specifically, path point information on the current point (the starting point Ps) at the time when the storage start instruction is performed is stored. Although a detailed description will be given later, the path point information is information on a point included in a stored path. Then, path point information on a point that becomes a current point as a result of the current point (target point) being moved by a moving operation performed by the user, is stored. It is noted that a specific operation method for the storage start instruction and a method for the moving operation are arbitrary, and the storage start instruction and the moving operation may be performed by any methods. In addition, in the present embodiment, the current point is moved to a point adjacent thereto in accordance with an operation of the user, and a method for determining a current point (target point) may be any method as long as it is a method in which one of points on the map is determined as a current point on the basis of an operation of the user.

FIG. 7 is a diagram showing an example of the data structure of path information. As shown in FIG. 7, the path information includes one or more pieces of path point information. Each piece of the path point information is information stored for one point. In the present embodiment, the path point information includes order information, position information, panoramic image information, and line-of-sight direction information.

The order information indicates an order of the corresponding point of points on the stored path (the point corresponding to the path point information including the order information). For example, for the points on the stored path, “1” is set for the starting point, and numbers increased in order from the starting point are assigned as order information. Although a detailed description will be given later, each panoramic image associated with each point on the path is reproduced (displayed) at the reception side in an order following the order information. In other words, the order information indicates a display order of panoramic images in a panoramic image reproduction process using the path information.

The position information is the above-described position information on the point (see FIG. 5). In addition, the panoramic image information is the same as the panoramic image information associated with the point in the map data (see FIG. 5).

The line-of-sight direction information indicates a line-of-sight direction determined on the basis of a line-of-sight direction at the point (referred to as a representative line-of-sight direction). Here, the “line-of-sight direction at the point” is a line-of-sight direction taken while the panoramic image at the point is displayed. The transmission-side apparatus 2 calculates a representative line-of-sight direction on the basis of a line-of-sight direction during a period when the panoramic image at the point is displayed. Specifically, the transmission-side apparatus 2 stores line-of-sight directions at predetermined time intervals during the above period, and calculates a representative line-of-sight direction on the basis of the stored line-of-sight directions after end of the above period.

A method for calculating the representative line-of-sight direction is arbitrary, but, for example, a method described next is conceivable. Specifically, the representative line-of-sight direction may be calculated as the average of the line-of-sight directions stored during the above period. In addition, the representative line-of-sight direction may be calculated as a line-of-sight direction taken for the longest time during the above period. Specifically, a range in which a line-of-sight direction can be taken is divided into a plurality of segments, and a line-of-sight direction corresponding to a segment including the most line-of-sight directions stored during the above period may be set as a representative line-of-sight direction. In addition, the final line-of-sight direction during the above period may be determined as a representative line-of-sight direction. As described above, the representative line-of-sight direction may be calculated so as to represent a direction in which the user sees during the above period. In addition, in another embodiment, the line-of-sight direction information may be information indicating each line-of-sight direction stored during the above period. Moreover, in this case, a representative line-of-sight direction may be calculated in the server or the reception-side apparatus that receives the path information.

As described above, in the present embodiment, for each panoramic image identified by the path information, the transmission-side apparatus 2 stores line-of-sight information indicating a representative line-of-sight direction determined on the basis of the line-of-sight direction when the panoramic image is displayed on the display section 14. Thus, the transmission-side apparatus 2 is able to store not only a path along which the current point is moved by the user but also a line-of-sight direction at each point.

It is noted that the path information may be any information as long as it is possible to reproduce a panoramic image at the reception side on the basis of the path information. For example, in another embodiment, the path information may not include line-of-sight direction information, and may include other information.

In generating path point information, the transmission-side apparatus 2 acquires the above position information and the above panoramic image information from the map data. It is noted that the map data may be previously acquired from the server, or may be acquired from the server at the timing at which path point information is generated. In addition, in generating path point information, the transmission-side apparatus 2 generates the above order information and the above line-of-sight direction information by the above-described method.

In the present embodiment, after storage of a path is started, the transmission-side apparatus 2 performs a process of storing path point information each time the current point is moved. It is noted that the timing at which path point information is generated and stored is arbitrary, but in the present embodiment, path point information is generated and stored at the timing at which the current point is moved. Specifically, when the current point is moved, the transmission-side apparatus 2 stores order information, position information, and panoramic image information of path point information on a point after the movement. In addition, in the above case, the transmission-side apparatus 2 stores line-of-sight direction information of path point information on a point before the movement. In the present embodiment, this is because, after the point is moved, it is made possible to generate line-of-sight direction information. In addition, when a predetermined end condition for ending the storage of the path is met, the transmission-side apparatus 2 stores line-of-sight direction information for the current point (end point) at that time point, and ends the storage of the path. It is noted that the above end condition is arbitrary, but in the present embodiment, a condition that the number of stored points reaches a predetermined number or a condition that the user performs a predetermined end instruction is set as an end condition.

(Process of Removing Some of Points and Storing Points)

In addition, in another embodiment, path point information on not all points on a stored path may be stored, and the path point information on only some of the points may be stored. That is, the path information may include only path point information on some of points that become current points during a period when the path is stored. In other words, the path information may be information that is capable of identifying panoramic images associated with some points that meet a predetermined removal condition, among the points that become current points during the above period. By this, it is possible to reduce a data amount of the path information.

The above removal condition is arbitrary. In other words, a method of selecting target points to be stored as path point information from among the points on the path is arbitrary. It is noted that, for example, the following method is conceivable as this selection method.

For example, the transmission-side apparatus 2 may select each target point to be stored, such that a distance to its position on the map is equal to or longer than a predetermined distance. Specifically, when the current point is moved, if the distance from the position of the last-stored point to the position of a point after the movement is equal to or longer than the predetermined distance, the transmission-side apparatus 2 may store the point after the movement. If the distance is less than the predetermined distance, the transmission-side apparatus 2 may not store the point after the movement. For example, in the example shown in FIG. 6, if a distance is short like the distance between the stored point P1 and the next point P2, the point P2 may not become a storage target, and a point P3 spaced apart from the point P1 by the predetermined distance or longer may be set as a storage target next. It is noted that it is possible to know the position of each point on the map by using the position information (latitude/longitude information) included in the map data.

In addition, for example, the transmission-side apparatus 2 may select points with which a path is identifiable, as storage targets. Specifically, the transmission-side apparatus 2 may select a starting point, points at intersections, and an end point on a path as storage targets. For example, in the example shown in FIG. 6, the starting point Ps, the points P1, P4, P7, P9, P10, and P12, and the end point Pg may be set as storage targets.

In addition, for example, the transmission-side apparatus 2 may select a point as a storage target once each time the current point is moved a predetermined number of times. It is noted that in this case, a point at an intersection may be preferentially selected (if a moved point is at an intersection, the point may be set as a storage target). Moreover, in the case where related information regarding a point (e.g., information indicating the name of a place, the name of a road, etc.) is included in the map data, a point may be selected as a storage target on the basis of the related information. For example, the transmission-side apparatus 2 may identify a type of a road (a highway or an ordinary road) along a path from the above related information, and may change the above predetermined number of times in accordance with a result of the identification.

As described above, the transmission-side apparatus 2 may select a point on the basis of a characteristic, on the map, calculated from the map data (a position on the map, whether a point is at an intersection, the above related information, etc.). According to this, the transmission-side apparatus 2 is able to appropriately perform the process of removing some points by taking the characteristic on the map into consideration.

(Input of Message)

In addition, in the present embodiment, the user is allowed to add a message about a stored path. Specifically, after the above end condition is met and storage of a path is ended, the transmission-side apparatus 2 receives an input of a message from the user. The message may be inputted as character information by character input, may be inputted as handwritten input information by touch input, or may be inputted as voice information by voice input. The inputted message is stored as message information with information for identifying the user (the name of the user, etc.). The transmission-side apparatus 2 transmits the above path information and the message information to the server 3. It is noted that the input of the message may be performed at arbitrary timing after the path information is stored. In addition, the transmission of the path information (and the message information) may be performed at arbitrary timing after the path information is stored. For example, the transmission-side apparatus 2 may be able to register (store) the stored path information as a favorite, and may transmit the path information registered as a favorite to the server 3 later (e.g., in accordance with an instruction of the user).

(Sharing of Individual Points)

In addition, in the present embodiment, in the information processing system 1, each information processing apparatus is able to share not only the path information but also information on individual points with each other. In other words, the transmission-side apparatus 2 is able to post information on individual points. Specifically, in accordance with an instruction being performed by the user, the transmission-side apparatus 2 stores panoramic image information indicating a panoramic image at the current point at the time point when the instruction is performed. Moreover, the transmission-side apparatus 2 stores line-of-sight direction information indicating a line-of-sight direction at the time point when the instruction is performed. The transmission-side apparatus 2 transmits, to the server 3, individual point information including the panoramic image information and the line-of-sight direction information. When a message is inputted by the user, the transmission-side apparatus 2 transmits message information with the individual point information to the server 3.

(4-2: Operation of Server in Receiving Path Information)

Next, an operation of the server 3 in receiving path information will be described. As described above, path information is transmitted (posted) from the transmission-side apparatus 2 and received by the server 3. Upon reception of the path information, the server 3 generates and stores posted path information including the path information. It is noted that the server 3 is able to receive path information from a plurality of transmission-side apparatuses, and generates posted path information for each received path information.

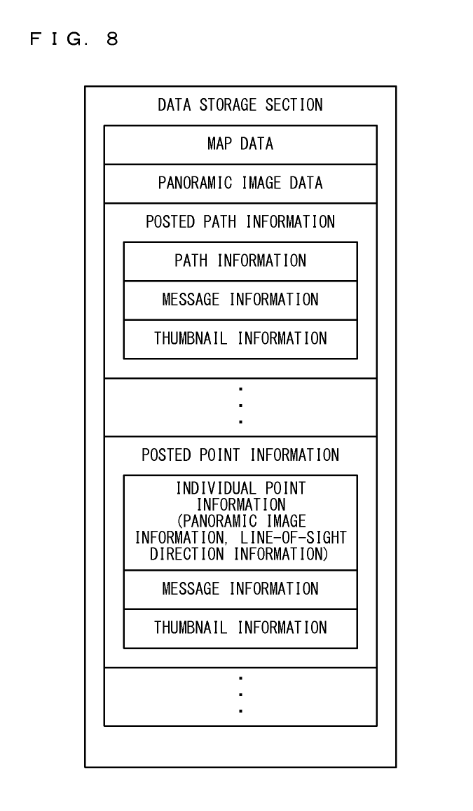

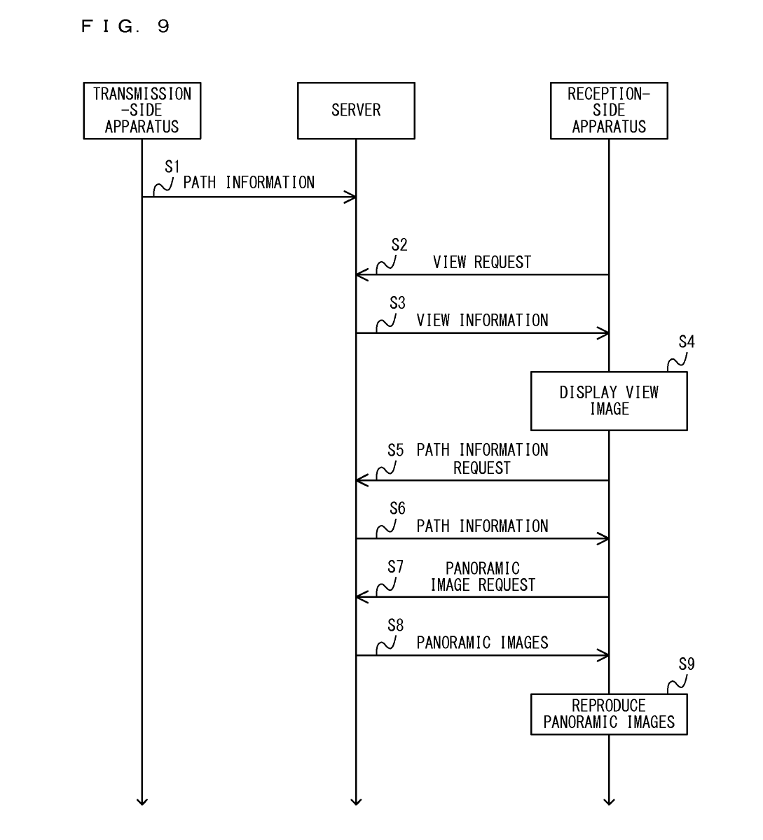

FIG. 8 is a diagram showing an example of data stored in the server. As shown in FIG. 8, the data storage section 23 of the server 3 has stored therein map data, panoramic image data, the above posted path information, and posted point information. The map data is the same as that described in the above [3. Map data associated with panoramic image]. In addition, the panoramic image data is image data of each panoramic image associated with each point on the map. It is noted that the server 3 may be composed of a plurality of server apparatuses, and the data (information) shown in FIG. 8 may be divided and stored in the plurality of server apparatuses. For example, a server apparatus for storing the map data and the panoramic image data and a server apparatus for storing the posted path information and the posted point information may be separately provided.

The posted path information is generated and stored for each posted (transmitted) path information. In the present embodiment, as shown in FIG. 8, the posted path information includes path information, message information, and thumbnail information. The path information and the message information are information transmitted from the transmission-side apparatus 2 and received by the server 3 as described above.

The thumbnail information is information indicating a thumbnail of a panoramic image identified by the corresponding path information. In other words, the thumbnail information indicates an image (thumbnail image) obtained from the panoramic image identified by the path information. In the present embodiment, the server 3 generates the thumbnail image on the basis of a panoramic image at the starting point of the path represented by the path information. More particularly, of the panoramic image at the starting point, an image of an area displayed at the time point when storage of the path is started is set as a thumbnail image. In addition, the thumbnail information includes URL information indicating the storage location (URL) at which the thumbnail image is stored in the server 3. It is noted that a coordinate of a point at which the thumbnail is displayed, a line-of-sight direction, etc. may be included in the thumbnail information instead of the URL information.

It is noted that the thumbnail information is an example of presentation information used for presenting the path information to the reception-side user (the reception-side apparatus 4), and is an example of presentation information representing the path information. In another embodiment, instead of the thumbnail information, any information representing the path on the map may be used as presentation information.

In addition, in the present embodiment, also regarding individual point information, similarly to the path information, posted point information is generated and stored for each individual point information. In the present embodiment, as shown in FIG. 8, the posted point information includes individual point information, message information, and thumbnail information. The individual point information and the message information are information transmitted from the transmission-side apparatus 2 and received by the server 3 as described above. The thumbnail information is information indicating a thumbnail of a panoramic image identified by the corresponding individual point information. For example, of the panoramic image at the point represented by the individual point information, the server 3 sets an image of an area displayed at the time point when an instruction for storage is performed, as a thumbnail image. In addition, also regarding the posted point information, similarly to the posted path information, the thumbnail information includes URL information.

(4-3: Operation Performed when Path Information is Received by Reception-Side Apparatus)

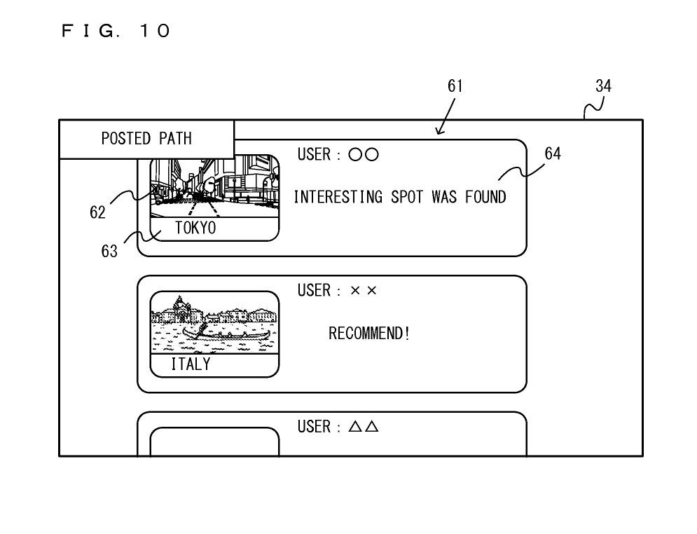

Next, an operation performed when path information is transmitted from the server 3 and received by the reception-side apparatus 4 will be described. FIG. 9 is a timing chart showing an example of flow of a process in the information processing system 1. As shown in FIG. 9, in the present embodiment, path information and the like are transmitted from the transmission-side apparatus 2 to the server 3 by the above-described method (step S1). Then, the server 3 generates and stores posted path information including the received path information. In this manner, the path information (posted path information) is uploaded to the server 3. Hereinafter, an operation performed when path information is transmitted to the reception-side apparatus 4 will be described on the assumption that one or more pieces of path information have been uploaded to the server 3.

First, the reception-side apparatus 4 transmits, to the server 3, a view request for viewing path information uploaded to the server 3 (step S2). The timing and the condition for the view request being transmitted are arbitrary, but in the present embodiment, the view request is transmitted in accordance with a predetermined instruction being performed by the user. It is noted that in a state where a panoramic image at a point desired by the user is displayed on the reception-side apparatus 4, the reception-side apparatus 4 may be able to transmit the view request in accordance with an instruction of the user. It is noted that although not shown in FIG. 9, in the present embodiment, the reception-side apparatus 4 is able to transmit a view request of individual point information in addition to the view request of path information. Which view request of path information or individual point information is transmitted is instructed by the user.

(Display of View Information)

Upon reception of the view request of path information, the server 3 transmits view information to the reception-side apparatus 4 (step S3). The reception-side apparatus 4 receives the view information and displays, on the display section 34, a view image based on the received view information (step S4).

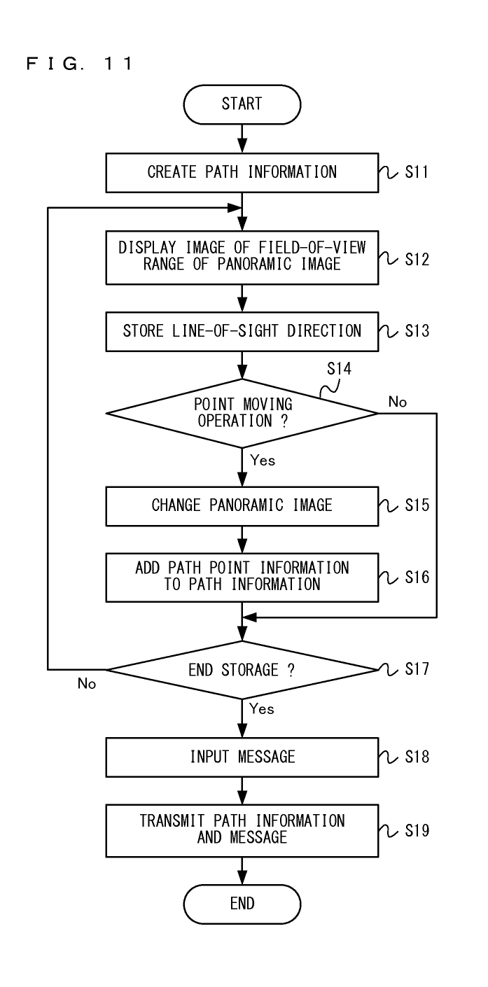

FIG. 10 is a diagram showing an example of a view image regarding path information. As shown in FIG. 10, the view image is an image representing a list of posted path images 61. One posted path image 61 represents one piece of path information (posted path information). As shown in FIG. 10, each posted path image 61 includes a thumbnail image 62, a place name image 63, and a message image 64. In this manner, in the reception-side apparatus 4, information including a thumbnail image, a place name, and a message is displayed for each piece of posted path information in a list of each path information. It is noted that as shown in FIG. 10, each posted path image 61 may include the name of the user who performs posting (identification information). In addition, in FIG. 10, it is possible to display another posted path image that is not displayed in FIG. 10, by scrolling up or down the image displayed on the screen.

As described above, in the present embodiment, the transmission-side apparatus 2 transmits, to the server 3, path information with a message inputted by the user. Then, the server 3 stores the message and presentation information (a thumbnail image) representing the path information, in a state where the message and the presentation information are viewable by the reception-side apparatus 4. Therefore, in the reception-side apparatus 4, it is possible to view the message and the presentation information as information regarding the posted path information (FIG. 10). Thus, it is possible to present the posted path information in an easy-to-understand manner for the reception-side user.

In addition, in the present embodiment, the above presentation information representing the path information is image information obtained from a panoramic image identified by the path information represented by the presentation information (i.e., information on a thumbnail image). This image information is displayed on the reception-side apparatus 4, whereby it is possible to present the posted path information in an easy-to-understand manner for the reception-side user.

When transmitting view information, the server 3 specifically generates view information including the message information and the thumbnail information of the above posted path information and transmits the view information. In the present embodiment, the server 3 determines a place name corresponding to the path information using the map data, further incorporates information indicating the place name into the view information, and transmits the view information.

In addition, the server 3 generates view information regarding a predetermined number of pieces of posted path information, and transmits the view information to the reception-side apparatus 4. For example, view information regarding the predetermined number of pieces of posted path information is transmitted in order from the most recently posted information. The reception-side apparatus 4 generates posted path images 61 on the basis of the received view information, and displays the posted path images 61 on the display section 34. Thus, the view image shown in FIG. 10 is displayed. It is noted that in a state where the view image is displayed, the reception-side apparatus 4 may acquire new view information (untransmitted view information regarding posted path information) from the server 3 by transmitting another view request to the server 3 in accordance with an instruction of the user, and may update the content of the view image with the acquired view information.

In the present embodiment, the reception-side apparatus 4 is able to acquire view information regarding individual point information from the server 3 in addition to view information regarding path information. In this case, the reception-side apparatus 4 transmits, to the server 3, a view request for acquiring view information regarding individual point information. In accordance with the view request, the server 3 generates view information regarding a predetermined number of pieces of posted point information, and transmits the view information to the reception-side apparatus 4. The view information regarding the individual point information may include any content in which presentation information representing the individual point information is included for each piece of individual point information. In the present embodiment, similarly to the path information, the view information regarding the individual point information includes message information, thumbnail information (as presentation information), and place name information. Therefore, the reception-side apparatus 4 that has received the view information is able to generate a view image similar to the view image regarding the path information and display the view image on the display section 34.

As described above, the transmission-side apparatus 2 stores individual point information with which a panoramic image associated with one point designated by the user is identifiable. The server 3 generates first presentation information (a thumbnail image) representing path information transmitted from one or more transmission-side apparatuses, for each path information, and generates second presentation information (a thumbnail image) representing individual point information transmitted from one or more transmission-side apparatuses, for each individual point information. In accordance with a first instruction of the user, the reception-side apparatus 4 acquires the first presentation information (view information including presentation information representing path information) from the server 3 and displays the first presentation information in a list on the display section 34. In accordance with a second instruction of the user, the reception-side apparatus 4 acquires the second presentation information (view information including presentation information representing individual point information) from the server 3 and displays the second presentation information in a list on the display section 34. As described above, in the present embodiment, in the reception-side apparatus 4, a list of posted path information and a list of posted individual point information are separately displayed, and the reception-side user is allowed to separately view these lists. According to this, it is possible to present posted path information and posted individual point information in an easy-to-understand manner for the user. It is noted that in another embodiment, path information and individual point information may be displayed on the same list screen. In this case, for example, the path information and the individual point information may be displayed so as to be distinguishable from each other by displaying different icons for the path information and the individual point information within the posted path image.

(Acquisition and Reproduction of Path Information)

In a state where a view image is displayed, the reception-side apparatus 4 selects one posted path image from among the posted path images included in the view image, in accordance with an instruction of the user. A method for the selection is arbitrary, and, for example, one of the posted path images is selected by an input (a touch input, etc.) of the user designating a thumbnail image. The reception-side apparatus 4 transmits, to the server 3, a request (path information request) for acquiring path information represented by the selected posted path image (step S5). Therefore, the server 3 that has receives the path information request transmits the identified path information to the reception-side apparatus 4 (step S6).

It is noted that in the present embodiment, in order that the reception-side apparatus 4 acquires presentation information (thumbnail image), acquisition information (URL information) associated with the presentation information (thumbnail information) is used. In addition, the reception-side apparatus 4 acquires a message and presentation information stored in the server 3 and displays the message and the presentation information on the display section 34. Then, when the presentation information displayed on the display section 34 is designated by the user, the reception-side apparatus 4 acquires, from the server 3, path information included in posted path information indicated by the designated presentation information. According to this, the reception-side apparatus 4 is able to easily acquire desired path information by the user designating presentation information (thumbnail image). It is noted that instead of the URL information, a coordinate of a point at which the thumbnail image is displayed, a line-of-sight direction, etc. may be stored as presentation information (acquisition information).

Upon reception of the path information, the reception-side apparatus 4 identifies panoramic images to be reproduced, on the basis of the received path information, and requests the server 3 to transmit the identified panoramic images (step S7). Specifically, the reception-side apparatus 4 requests the server 3 for panoramic images indicated by panoramic image information included in the path information. In response to this, the server 3 transmits the requested panoramic images (step S8).

Next, the reception-side apparatus 4 reproduces a plurality of received panoramic images (step S9). Specifically, each panoramic image is displayed in an order following the order information included in the path information. Thus, the panoramic images are reproduced on the reception-side apparatus 4 in an order along the path. It is noted that the path information includes a plurality of pieces of panoramic image information. The reception-side apparatus 4 may start reproduction after the reception-side apparatus 4 acquires all panoramic images included in the path information, or may start reproduction at a time when the reception-side apparatus 4 acquires some of all the panoramic images.

During reproduction of the panoramic image on the reception-side apparatus 4, a current point is moved along the path represented by the path information. The displayed panoramic image is updated in accordance with movement of the current point. Here, the reproduction speed of the panoramic image (the update interval of the panoramic image, that is, the moving speed of the current point) is arbitrary. The panoramic image may be updated every given time period, or may be updated in accordance with an instruction of the user. In addition, in another embodiment, information on a reproduction speed designated by the transmission-side user may be included in the path information, and the reception-side apparatus 4 may reproduce the panoramic image in accordance with the information on the reproduction speed included in the path information.

A method for determining a display range of the panoramic image during reproduction of the panoramic image on the reception-side apparatus 4 is arbitrary. For example, a line-of-sight direction (field-of-view range) may be determined on the basis of line-of-sight direction information included in the path information, and an image of the determined field-of-view range of the panoramic image may be displayed on the display section 34. In other words, the reception-side apparatus 4 may display, on the display section 34, an image of a partial area, determined on the basis of the line-of-sight direction information, of the acquired panoramic image. According to this, it is possible to determine a line-of-sight direction for the panoramic image displayed at the reception side, by reflecting the line-of-sight direction for the panoramic image displayed at the transmission side. Accordingly, for example, the reception-side user is allowed to know a direction in which the transmission-side user sees, and it is possible to present a panoramic image having enhanced interest.

In addition, in another embodiment, for example, the line-of-sight direction may be controlled in accordance with an operation of the user by the method described in the above “(Operation of line-of-sight direction)”. In addition, the reception-side apparatus 4 may display both an image of a display range determined on the basis of the line-of-sight direction information and an image of a display range controlled on the basis of an operation of the user. Furthermore, the reception-side apparatus 4 may control the line-of-sight direction in accordance with a predetermined algorism. For example, the reception-side apparatus 4 may control the line-of-sight direction such that the line-of-sight direction is directed in a traveling direction of the path (a direction from the current point to a point to which the current point is moved along the path next).

It is noted that in the present embodiment, transmission of path information and transmission of panoramic images are separately performed, but in another embodiment, the server 3 transmits the path information and the panoramic images together to the reception-side apparatus 4. In other words, in step S6, the server 3 may transmit path information and panoramic images indicated by panoramic image information included in the path information, to the reception-side apparatus 4. At that time, a process of identifying panoramic images on the basis of the path information is not necessary for the reception-side apparatus 4. In addition, in another embodiment, path information may not be necessarily transmitted to the reception-side apparatus 4, and the server 3 may not transmit path information to the reception-side apparatus 4 and may transmit panoramic images identified by the path information to the reception-side apparatus 4.

As described above, in the present embodiment, the transmission-side apparatus 2 displays, on the display section 14, an image of a partial area (display range), corresponding to a line-of-sight direction determined in accordance with an operation of the user, of a panoramic image associated with a current point. In addition, the transmission-side apparatus 2 stores path information with which two or more panoramic images of panoramic images associated with points on a path along which the current point is moved during a predetermined period, and an order of the two or more panoramic images are identifiable. The reception-side apparatus 4 acquires the two or more panoramic images identified by the path information stored in the transmission-side apparatus 2, and displays the acquired two or more panoramic images on the display section 34 in the order identified by the path information. In this manner, in the present embodiment, it is possible to share the path along each point at which the panoramic image is reproduced, by the transmission side and the reception side. At the reception side, in addition to merely viewing a panoramic image while moving a point, it is possible to view panoramic images along a path that is viewed by the user of another apparatus, and it is possible to view a panoramic image in an unconventional way of enjoyment.

In addition, in the present embodiment, the information processing system 1 further includes the server 3 capable of communicating with each of the information processing apparatuses 2 and 4. The transmission-side apparatus 2 transmits stored path information to the server 3, and the server 3 stores the path information transmitted from the transmission-side apparatus 2. Then, the reception-side apparatus 4 acquires panoramic images identified by the path information stored in the server 3. In the present embodiment, the path information is uploaded to the server and stored therein as described above, and thus it is possible to easily share the path information by a large number of information processing apparatuses. It is noted that in another embodiment, the information processing system 1 may not include the server 3, and the transmission-side apparatus 2 and the reception-side apparatus 4 may directly transmit/receive information (path information, etc.) to/from each other.

[5. Details of Information Processing]

(5-1: Process in Transmission-Side Apparatus)

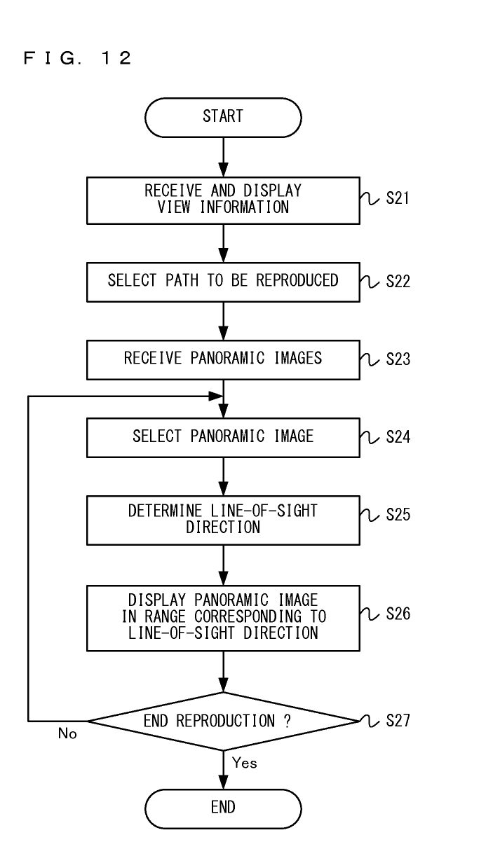

Hereinafter, a specific example of the path storage process performed by the transmission-side apparatus 2 in the present embodiment will be described. FIG. 11 is a flowchart showing an example of flow of the path storage process performed by the transmission-side apparatus 2 (CPU 11) in the present embodiment. In the present embodiment, a series of processes shown in FIG. 11 are performed by the CPU 11 executing information processing program stored in the data storage section 13.

It is noted that the timing at which the path storage process shown in FIG. 11 is started is arbitrary. In the present embodiment, execution of the information processing program is started in accordance with the user performing an instruction for starting display of a panoramic image. At that time, a part or the entirety of the information processing program is loaded into the memory 12 at appropriate timing, and executed by the CPU 11. Then, the series of processes shown in FIG. 11 are started in accordance with the user performing an instruction for starting storage of a path. It is noted that the information processing program has been previously stored in the data storage section 13 within the transmission-side apparatus 2. However, in another embodiment, the display control program may be acquired by the transmission-side apparatus 2 from an attachable/detachable storage medium and stored into the memory 12, or may be acquired from another apparatus via a network such as the Internet and stored into the memory 12.

It is noted that a process in each step in the flowcharts shown in FIGS. 11 and 12 is merely an example, and as long as the same result is obtained, the order of the processes in the respective steps may be changed, or another process may be performed in addition to (or instead of) the process in each step. In addition, in the present embodiment, the CPU 11 or 31 performs the process in each step in the above flowcharts. However, a processor or a dedicated circuit other than the CPU 11 or 31 may perform the processes at some of the steps in the above flowcharts.

In the path storage process, first, in step S11, the CPU 11 generates path information and stores the path information into the memory 12. Specifically, path point information (excluding line-of-sight direction information) regarding the current point (starting point) is generated according to the method described in the above “(4-1: Operation in transmission-side apparatus)”, and path information including the path point information is stored into the memory 12.

In step S12, the CPU 11 generates an image of a field-of-view range, determined in accordance with the attitude of the transmission-side apparatus 2, of a panoramic image, and displays the generated image on the display section 14. Specifically, according to the method described in the above “[2. Display of panoramic image]”, the CPU 11 generates an image of a field-of-view range and displays the image on the display section 34.

In step S13, the CPU 11 stores the current line-of-sight direction into the memory 12. In the present embodiment, a process loop of steps S12 to S17 is repeatedly executed every predetermined period of time. As a result, a line-of-sight direction is repeatedly stored every predetermined period of time.

In step S14, the CPU 11 determines whether a moving operation of moving a point has been performed by the user. This determination is performed on the basis of operation data acquired from the input section 15. When a result of the determination in step S14 is positive, a process in step S15 is performed. On the other hand, when the result of the determination in step S14 is negative, the processes in steps S15 and S16 are skipped, and a process in step S17 described later is performed.

In step S15, the CPU 11 changes the displayed panoramic image to a panoramic image associated with the current point after the movement by the moving operation. Thus, in step S12 that is performed next time, the panoramic image after the change is rendered on the three-dimensional model 51, and the panoramic image at the point after the movement is displayed.

In step S16, the CPU 11 adds path point information to the path information stored in the memory 12. Specifically, regarding path point information indicating the point after the movement, order information, position information, and panoramic image information are added, and regarding path point information indicating the point before the movement, line-of-sight direction information is added. The details of each added information is described in the above “(4-1: Operation in transmission-side apparatus)”.

In step S17, the CPU 11 determines whether an instruction for ending the storage of the path has been performed by the user. This determination is performed on the basis of operation data acquired from the input section 15. When a result of the determination in step S17 is negative, the process in step S12 is performed again. Thereafter, the process loop of steps S12 to S17 is repeatedly executed until it is determined in step S17 that the instruction for ending the storage of the path has been performed. On the other hand, when the result of the determination in step S17 is positive, a process in step S18 is performed. It is noted that at that time, the path information stored in the memory 12 is updated such that line-of-sight direction information of path point information indicating an end point is added.

In step S18, the CPU 11 receives an input of a message from the user using the input section 15. When the input of the message is performed, information on the inputted message and identification information on the user are stored into the memory 12.

In step S19, the CPU 11 transmits the path information and the message information to the server 3 via a network. Accordingly, the server 3 generates posted path information including the path information and the message information and stores the posted path information into the data storage section 23 (for the details thereof, see the above “(4-2: Operation of server in receiving path information)”).

It is noted that although not shown in FIG. 11, the transmission-side apparatus 2 is able to generate individual point information and transmit the individual point information to the server 3 as described above. For example, in the process loop of steps S12 to S17, the CPU 11 may determine whether an instruction for storing individual point information has been performed by the user, and when the instruction has been performed, the CPU 11 may generate individual point information regarding the current point.

(5-2: Process in Reception-Side Apparatus)

Next, a specific example of the image reproduction process performed by the reception-side apparatus 4 in the present embodiment will be described. FIG. 12 is a flowchart showing an example of flow of the image reproduction process performed by the reception-side apparatus 4 (CPU 31) in the present embodiment. In the present embodiment, a series of processes shown in FIG. 12 are performed by the CPU 31 executing an information processing program stored in the data storage section 33.

It is noted that the timing at which the image reproduction process shown in FIG. 12 is arbitrary. In the present embodiment, execution of the information processing program is started in accordance with the user performing an instruction for starting display of a panoramic image. At that time, a part or the entirety of the information processing program is loaded into the memory 32 at appropriate timing, and executed by the CPU 31. Then, the series of processes shown in FIG. 12 are started in accordance with the user performing an instruction for starting reproduction of a panoramic image using path information. It is noted that the information processing program executed at the reception side may be acquired and stored into the memory 32 by any method similarly to the transmission side.

In the image reproduction process, first, in step S21, the CPU 31 receives view information from the server 3 and displays a view image on the display section 34. The details of operations of the reception-side apparatus 4 and the server 3 regarding step S21 are described as the processes in steps S2 to S4 described above.

In step S22, in accordance with an instruction of the user, the CPU 31 selects one piece of path information to be reproduced, from among path information displayed as the view image. In subsequent step S23, the CPU 31 receives (acquires) panoramic images regarding the selected path information from the server 3. The details of operations of the reception-side apparatus 4 and the server 3 regarding steps S22 and S23 are as described in the above “(Acquisition and reproduction of path information)”.

In step S24, the CPU 31 selects a panoramic image to be displayed, from among the panoramic images acquired from the server 3. During a period when a process loop of steps S24 to S27 is repeatedly executed, the CPU 31 sequentially selects a panoramic image to be displayed, in accordance with an order indicated by the order information included in the path information acquired from the server 3. In addition, during the period, the CPU 31 changes the selected panoramic image at a time interval corresponding to a reproduction speed determined by the method described in the above “(Acquisition and reproduction of path information)”, such that the selected panoramic image is reproduced at the reproduction speed.

In step S25, the CPU 31 determines a line-of-sight direction. In subsequent step S26, the CPU 31 displays, on the display section 34, a panoramic image of a field-of-view range corresponding to the determined line-of-sight direction. In other words, a line-of-sight direction is determined by the method described in the above “(Acquisition and reproduction of path information)”, and an image of a partial area of the panoramic image is displayed on the display section 34 by the method described in the above (Method for displaying panoramic image)”. By the processes in steps S24 to S26 being repeatedly performed, a plurality of panoramic images are reproduced on the reception-side apparatus 4 along the path represented by the path information.

In step S27, the CPU 31 determines whether to end the reproduction process. A specific method for this determination is arbitrary. However, in the present embodiment, the CPU 11 determines to end the reproduction process, when display of all the panoramic images associated with the path information is ended or when an instruction for stopping the reproduction is performed by the user. When a result of the determination in step S27 is negative, the process in step S24 is performed again. Thereafter, the processes in steps S24 to S27 are repeatedly performed until it is determined in step S27 to end the reproduction process. On the other hand, when the result of the determination in step S27 is positive, the CPU 31 ends the image reproduction process shown in FIG. 12.

It is noted that although not shown in FIG. 12, the reception-side apparatus 4 is able to acquire individual point information and display a panoramic image at a point indicated by the individual point information as described above. For example, in steps S21 to S23, the CPU 31 may acquire view information regarding individual point information and may acquire a panoramic image associated with the individual point information. Then, the CPU 31 may select the acquired panoramic image in step S24 and may display a partial area of the panoramic image on the display section 34 in steps S25 and S26.

[6. Modifications]

(Modifications Regarding Supplementation with Points on Path During Reproduction)

In the embodiment described above, when some of points to be stored are removed from points on the path (only some of the points are stored), the reception-side apparatus 4 may perform supplementation with points that have not been stored, on the basis of the path information. Then, the reception-side apparatus 4 may reproduce panoramic images regarding the points whose path point information is included in the path information and the points obtained by the supplementation (supplementary points). According to this, it is possible to reproduce panoramic images regarding more points at the reception side while a data amount of the path information is reduced.

It is noted that the above supplementation may be performed at the server side. In other words, the server 3 that has received path information from the transmission-side apparatus 2 may perform the above supplementation, and may store posted path information in which path point information on supplementary points are included in the path information. According to this, it is possible to reproduce panoramic images regarding more points at the reception side while a processing load in the reception-side apparatus 4 is reduced.

In addition, in the case where the above supplementation is performed, for the supplementary points, path point information may be stored so as to not include line-of-sight direction information. Or, in the server 3 or the reception-side apparatus 4, line-of-sight direction information at supplementary points may be generated (added) by using line-of-sight direction information at the points other than the supplementary points. For example, in the example shown in FIG. 6, a case is considered in which path point information on the points P7 and P9 is stored and a line-of-sight direction at the point P8 is added. In this case, the added line-of-sight direction at the point P8 may be calculated as the average of a line-of-sight direction at the point P7 and a line-of-sight direction at the point P9. As described above, by the supplementation with the line-of-sight direction information, the reception-side apparatus 4 is able to determine a line-of-sight direction on the basis of the line-of-sight direction information also for each supplementary point similarly to the points other than the supplementary points, and determine a display range of a panoramic image.

(Modifications Regarding Input of Path)

In the embodiment described above, regarding a path obtained as a result of an actual operation performed by the user on the transmission-side apparatus 2, path information is generated and transmitted to the server 3. Here, in another embodiment, the path information may be changeable by the user, and the changed path information may be transmitted from the transmission-side apparatus 2 to the server 3. For example, the user may be allowed to correct a path represented by path information in the transmission-side apparatus 2. Furthermore, path information changed by the user may be path information generated in the transmission-side apparatus 2, or may be path information acquired from the server 3 (generated in another information processing apparatus).

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-designed ASICs (application specific integrated circuits) and/or logic circuitry. In the case of a distributed processor architecture or arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

For the purpose of, for example, presenting a panoramic image having enhanced interest, it is possible to use the present embodiment as an information processing system or an information processing apparatus for displaying a panoramic image on a display device.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system comprising a plurality of information processing apparatuses each capable of displaying, on a display device, a plurality of panoramic images associated with points on a map,
a transmission-side apparatus of the plurality of information processing apparatuses comprising:
a point determination unit configured to determine one of points on the map as a target point on the basis of an operation of a user;
a first image display unit configured to display, on a first display device, an image of a partial area, corresponding to a line-of-sight direction determined in accordance with an operation of the user, of a panoramic image associated with the target point; and
a path information storage unit configured to store path information which allows for identification of two or more panoramic images of panoramic images associated with points on a path along which the target point is moved during a predetermined period, and identification of an order of the two or more panoramic images,
a reception-side apparatus of the plurality of information processing apparatuses comprising:
a panoramic image acquisition unit configured to acquire the two or more panoramic images identified by the path information stored in the transmission-side apparatus; and
a second image display unit configured to display, on a second display device, the acquired two or more panoramic images in the order identified by the path information.

2. The information processing system according to claim 1, further comprising a server capable of communicating with each information processing apparatus, wherein
the transmission-side apparatus further comprises a transmission unit configured to transmit the stored path information to the server,
the server stores the path information transmitted from the transmission-side apparatus, and
the panoramic image acquisition unit acquires the panoramic images identified by the path information stored in the server.

3. The information processing system according to claim 2, wherein
the transmission unit transmits, to the server, the path information with a message inputted by the user, and
the server stores the message and first presentation information representing the path information, in a state where the message and the first presentation information are viewable by each information processing apparatus.

4. The information processing system according to claim 3, wherein the first presentation information is image information obtained from the panoramic image identified by the path information represented by the first presentation information.

5. The information processing system according to claim 2, wherein the transmission-side information processing apparatus further comprises an individual information storage unit configured to store individual point information which allows for identification of a panoramic image associated with one point designated by the user,
the server generates first presentation information representing path information transmitted from one or more transmission-side apparatuses, for each path information, and generates second presentation information representing individual point information transmitted from one or more transmission-side apparatuses, for each individual point information, and
the reception-side apparatus further comprises a list display section configured to: acquire the first presentation information from the server and display the first presentation information in a list on the second display device in accordance with a first instruction of a user; and acquire the second presentation information from the server and display the second presentation information in a list on the second display device in accordance with a second instruction of the user.

6. The information processing system according to claim 1, wherein, for each panoramic image identified by the path information, the path information storage unit stores path information including line-of-sight direction information indicating a line-of-sight direction determined on the basis of a line-of-sight direction when the panoramic image is displayed on the first display device.

7. The information processing system according to claim 6, wherein the second image display unit displays, on the second display device, an image of a partial area, determined on the basis of the line-of-sight direction information included in the path information, of the acquired panoramic image.

8. The information processing system according to claim 1, wherein the path information storage unit stores path information which allows for identification of panoramic images associated with some points that meet a predetermined condition, among points that become target points during the predetermined period.

9. The information processing system according to claim 8, wherein the path information storage unit selects the some points on the basis of a characteristic, on the map, which is calculated from map data representing the map, and stores path information which allows for identification of panoramic images associated with the selected points.

10. An information processing apparatus capable of displaying, on a display device, a plurality of panoramic images associated with points on a map, the information processing apparatus comprising:
a point determination unit configured to determine one of points on the map as a target point on the basis of an operation of a user;
an image display unit configured to display, on the display device, an image of a partial area, determined in accordance with an operation of the user, of a panoramic image associated with the target point;
a path information storage unit configured to store path information which allows for identification of two or more panoramic images of panoramic images displayed on the display device in accordance with the target point being moved during a predetermined period, and identification of a display order of the two or more panoramic images; and
a transmission unit configured to transmit the path information to another information processing apparatus.

11. A computer-readable non-transitory storage medium having stored therein an information processing program executed by a computer of an information processing apparatus capable of displaying, on a display device, a plurality of panoramic images associated with points on a map, the information processing program causing the computer to execute:
determining one of points on the map as a target point on the basis of an operation of a user;
displaying, on the display device, an image of a partial area, determined in accordance with an operation of the user, of a panoramic image associated with the target point;
storing, into a storage unit of the information processing apparatus, path information which allows for identification of two or more panoramic images of panoramic images displayed on the display device in accordance with the target point being moved during a predetermined period, and identification of a display order of the two or more panoramic images; and
transmitting the path information to another information processing apparatus.

12. An information transmission/reception method executed in an information processing system comprising a plurality of information processing apparatuses each capable of displaying, on a display device, a plurality of panoramic images associated with points on a map,
a transmission-side apparatus of the plurality of information processing apparatuses:
determining one of points on the map as a target point on the basis of an operation of a user;
displaying, on a first display device, an image of a partial area, corresponding to a line-of-sight direction determined in accordance with an operation of the user, of a panoramic image associated with the target point; and
storing path information which allows for identification of two or more panoramic images of panoramic images associated with points on a path along which the target point is moved during a predetermined period, and identification of an order of the two or more panoramic images,
a reception-side apparatus of the plurality of information processing apparatuses:
acquiring the two or more panoramic images identified by the path information stored in the transmission-side apparatus; and
displaying, on a second display device, the acquired two or more panoramic images in the order identified by the path information.
